(19) United States
(12) Patent Application Publication
(10) Pub. No.: US 2014/0127554 A1
(43) Pub. Date: May 8, 2014

(54) BATTERY PACK

(71) Applicant: PANASONIC CORPORATION, Osaka (JP)

(72) Inventors: Shinsuke Fukuda, Hyogo (JP); Yasumi Fukumoto, Osaka (JP)

(21) Appl. No.: 14/130,902

(22) PCT Filed: Oct. 18, 2012
(86) PCT No.: PCT/JP2012/006679

§ 371 Date: Jan. 3, 2014

(30) Foreign Application Priority Data
Nov. 25, 2011 (JP) 2011-257532

(51) Int. Cl. H01M 2/24; H01M 10/42

(52) U.S. Cl. CPC H01M 2/24; H01M 10/425
USPC 429/158

(57) ABSTRACT

A battery pack includes a plurality of batteries, a lead plate, and a circuit board. The plurality of batteries are connected with one another. The lead plate are connected with the plurality of batteries, and made of a conductive material. The circuit board is connected with the plurality of batteries through the lead plate. The circuit board includes insertion holes passing through the circuit board along the thickness thereof. The lead plate includes an insertion part disposed in the insertion hole. The insertion part is folded and is thicker than the other part of the lead plate.

### TECHNICAL FIELD

The present invention relates to battery packs, more particularly to a battery pack including a circuit board.

### BACKGROUND ART

A variety of recent electronic equipment include a battery pack, as a power supply, including a plurality of batteries connected together and accommodated in a battery case. For example, the equipment requiring high voltage includes a battery pack including a plurality of batteries connected in series. The equipment requiring a high current value includes a battery pack including a plurality of batteries connected in parallel.

These battery packs generally include a plurality of batteries, metallic lead plates, a circuit board, a resin case, etc. The metallic lead plates electrically connect the plurality of batteries with one another. The circuit board enables the batteries to charge or discharge safely. The resin case accommodates these components.

The plurality of batteries are connected with the lead plates by a welding method such as resistance welding. The plurality of batteries are also connected with one another in series or parallel in the preferred numbers of rows and columns through the lead plates.

The batteries and the circuit board are customarily connected by lead wires covered by resin tubes. One end of the lead wire is connected with the circuit board by, e.g., soldering. The other end of the lead wire is connected with the lead plate connected with the battery by, e.g., soldering. Such a method raises the cost of the lead wires covered by the resin tubes, and the number of connections by soldering. Patent Documents 1 and 2 describe a battery pack as a solution to this problem. This battery pack includes a lead plate directly connected with a circuit board.

FIG. 9 illustrates the battery pack disclosed in those documents. The battery pack includes a circuit board 103 and lead plates 105. The circuit board 103 includes insertion holes 103A. The lead plate 105 includes an insertion part 105A. The insertion part 105A is disposed in the insertion hole 103A. The insertion part 105A disposed in the insertion hole 103A may be or may not be bent along a surface of the circuit board 103. The insertion part 105A is soldered to a conductive part disposed on the surface of the circuit board 103. In this manner, the lead plates 105 are directly connected with the circuit board 103.

### CITATION LIST

### Patent Document

Patent Document 1: Japanese Unexamined Patent Publication No. 2008-34296

Patent Document 2: Japanese Unexamined Patent Publication No. 2005-317460

### SUMMARY OF THE INVENTION

### Technical Problem

In the components of the battery pack, the circuit board 103 costs much, next to the battery. Thus, the circuit board 103 that is small is useful for the cost reduction.

However, the lead plate 105 directly connected to the circuit board 103 as disclosed in Patent Documents 1 and 2 might be broken at a break line 105F in FIG. 10 when the battery pack is e.g., dropped and impacted. Thus, the width W of the insertion part 105A cannot be narrow. The width X of the insertion hole 103A also cannot be narrow. Consequently, the width Y of the circuit board 103 cannot be narrow.

The insertion hole 103A of the circuit board 103 is broadly categorized into a laterally long shape in FIG. 11 or a vertically long shape in FIG. 12. In this specification, the direction along a short side (the width) of the circuit board 103 is defined as the vertical (top-bottom) direction. The direction along a long side (the length) of the circuit board 103 is defined as the lateral (right-left) direction. The vertically long shape in FIG. 12, which makes the yield of the lead plate 105 better than the laterally long shape does, is more preferable.

However, as illustrated in FIG. 12, the lead plate 105 connected with a central portion of the circuit board 103 includes a cranked portion 105G that occupies a large region in a back side of the circuit board 103. This occupied region is a region 103C on which the components cannot be attached. Thus, as illustrated in FIG. 13, the insertion holes 103A are preferably disposed on the four corners of the circuit board 103 to secure as large a region, on the circuit board 103, on which the components can be attached as possible.

While securing a large area, on the circuit board 103, on which the components can be attached, this configuration inevitably increases the vertical size (width) of the circuit board 103, and thus does not allow the battery pack to be small.

It is an object of the present invention to provide a small, economical battery pack with high impact resistance where the battery pack includes a lead plate including an insertion part having the improved strength, and includes a small circuit board.

### Solution to Problem

For the above object, the battery pack of the present invention includes a lead plate including an insertion part that is folded and is thicker than the other part of lead plate.

Specifically, the battery pack of the present invention includes a plurality of batteries, the lead plate, and a circuit board. The plurality of batteries are connected with one another. The lead plate are connected with the plurality of batteries, and made of a conductive material. The circuit board is connected with the plurality of batteries through the lead plate. The circuit board includes insertion holes passing through the circuit board along the thickness thereof. The lead plate includes an insertion part disposed in the insertion hole. The insertion part is folded and is thicker than the other part of the lead plate.

The battery pack of the present invention includes the lead plate including the insertion part that is folded and is thicker than the other part of the lead plate. Thus, the insertion part of the lead plate has an improved strength, and the lead plate is small. Accordingly, the circuit board is small. Consequently, the battery pack that is small and economical, and has a high impact resistance is obtained.

### Advantages of the Invention

The battery pack of the present invention includes a lead plate including a small insertion part having a fully improved strength. Accordingly, the circuit board is small. Consequently, the battery pack that is small and economical, and has a high impact resistance is obtained.

### BRIEF DESCRIPTION OF THE DRAWINGS

FIG. 1(a) is an exploded perspective view of a battery pack of a first embodiment of the present invention. FIG. 1(b) is a cross-sectional view taken along line Ib-Ib of FIG. 1(a).

FIG. 2(a) illustrates the shape of an unfolded insertion part of a lead plate of the battery pack of the first embodiment of the present invention. FIG. 2(b) illustrates the shape of a folded insertion part of the lead plate.

FIGS. 3(a) and 3(b) illustrate that the insertion part of the lead plate of the battery pack of the first embodiment of the present invention is disposed in an insertion hole of a circuit board. FIG. 3(a) is a cross-sectional view taken along line IIIa-IIIa of FIG. 3(b). FIG. 3(b) is a plan view of the circuit board.

FIG. 4 illustrates a first alternative example of the insertion part of the lead plate of the battery pack of the first embodiment of the present invention.

FIG. 5 illustrates a second alternative example of the insertion part of the lead plate of the battery pack of the first embodiment of the present invention.

FIG. 6(a) illustrates the shape of an unfold insertion part of a lead plate of a battery pack of a second embodiment of the present invention. FIG. 6(b) illustrates a folded insertion part of the lead plate.

FIGS. 7(a) and 7(b) illustrate that the insertion part of the lead plate of the battery pack of the second embodiment of the present invention is disposed in an insertion hole of a circuit board. FIG. 7(a) is a cross-sectional view taken along line VIIa-VIIa of FIG. 7(b). FIG. 7(b) is a plan view of the circuit board.

FIG. 8 illustrates one example of layouts of the insertion hole of the circuit board and the lead plate of the battery pack of the first embodiment and the second embodiment of the present invention.

FIG. 9 is a perspective view of a conventional battery pack, and illustrates a connection between a circuit board and lead plates, and the surrounding area.

FIGS. 10(a) and 10(b) illustrate a conventional battery pack of which an insertion part of a lead plate is disposed in an insertion hole of a circuit board. FIG. 10(a) is a cross-sectional view taken along line IXa-IXa of FIG. 10(b). FIG. 10(b) is a plan view of the circuit board.

FIG. 11 illustrates one example of layouts of insertion holes of a circuit board and lead plates of a conventional battery pack.

FIG. 12 illustrates another example of layouts of insertion holes of a circuit board and lead plates of a conventional battery pack.

FIG. 13 illustrates another example of layouts of insertion holes of a circuit board and lead plates of a conventional battery pack.

### DESCRIPTION OF EMBODIMENTS

Embodiments of the present invention will be described in detail with reference to the drawings. Note that the present invention is not limited to the embodiments described below. Moreover, these embodiments may be modified within the scope of the advantage of the present invention. Furthermore, the embodiment may be combined with the other embodiment, or alternative examples thereof.

### First Embodiment

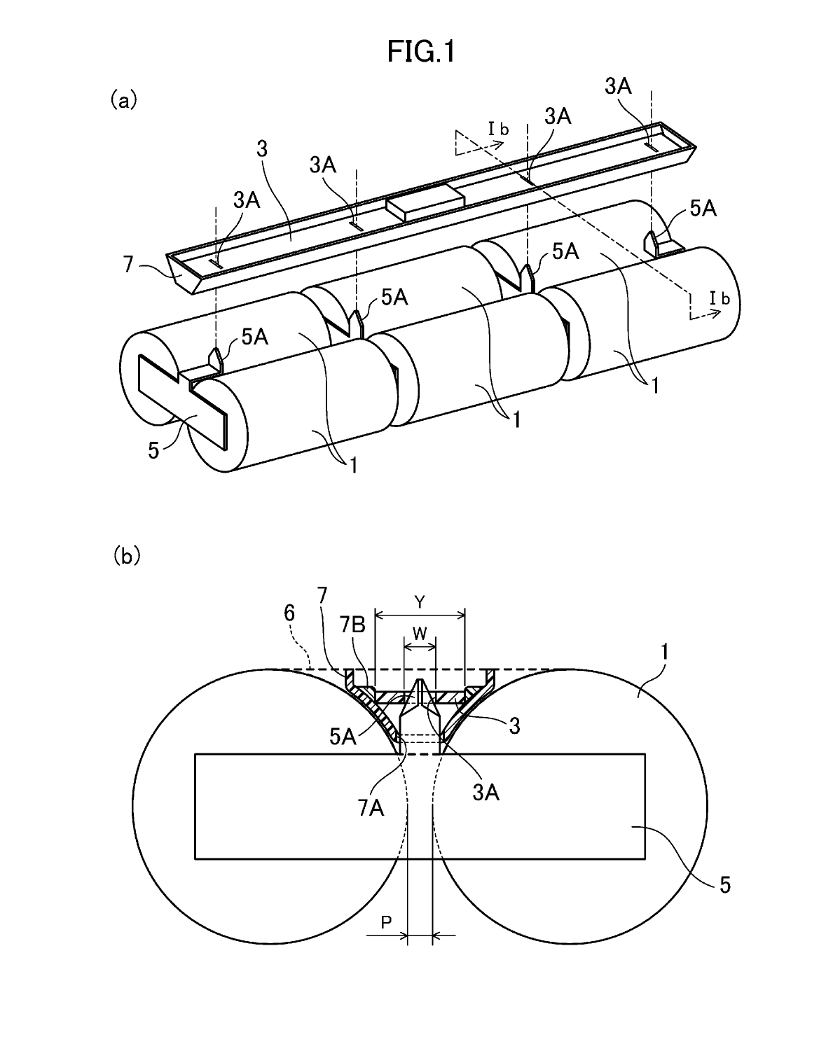

First, a battery pack of the first embodiment of the present invention will be described with reference to FIG. 1. FIG. 1(a) is an exploded perspective view illustrating a battery pack of this embodiment. FIG. 1(b) is a cross-sectional view taken along line Ib-Ib of FIG. 1(a).

FIG. 1(a) illustrates that the battery pack of this embodiment includes six cylindrical batteries 1. Two of these batteries are connected in parallel, and three in series. Note that, regardless this configuration, the plurality of batteries 1 only have to be connected together. The battery pack of this embodiment includes lead plates 5, each connected with a positive electrode or a negative electrode of the battery 1. The lead plate 5 extends from a portion connected with the battery 1 to a circuit board 3 described later. A tip end of lead plate 5 is an insertion part 5A connected with the circuit board 3.

The circuit board 3 is disposed on side surfaces of the plurality of batteries 1 (or, in FIG. 1(a), disposed above the plurality of batteries 1). The circuit board 3 is accommodated in a circuit board holder 7, which is made of resin and has a bottom. FIG. 1(b) illustrates that the circuit board holder 7 accommodating the circuit board 3 is in a clearance space 6 between the batteries 1.

In addition, FIGS. 1(a) and 1(b) illustrate that the circuit board 3 includes insertion holes 3A, which pass through the circuit board 3 along the thickness thereof. The insertion part 5A of the lead plate 5 is disposed in the insertion hole 3A. The insertion part 5A is soldered to the insertion hole 3A to fix the circuit board 3 to the lead plate 5. The circuit board holder 7 also includes through holes 7A disposed over the insertion holes 3A of the circuit board 3. Thus, the insertion part 5A of the lead plate 5 can pass though the through hole 7A. The circuit board holder 7 includes alignment ribs 7B, which align the circuit board 3 correctly. The alignment ribs 7B align the insertion holes 3A of the circuit board 3, the through holes 7A of the circuit board holder 7, and the insertion parts 5A of the lead plate 5. The battery pack includes a battery case (not shown), which accommodates the plurality of batteries 1, the circuit board 3 accommodated in the circuit board holder 7, and the lead plates 5.

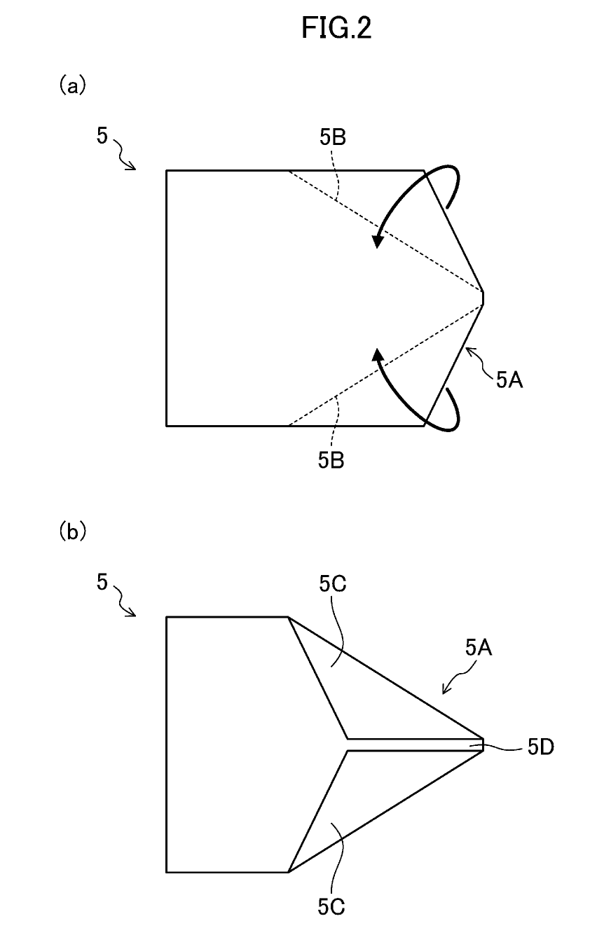

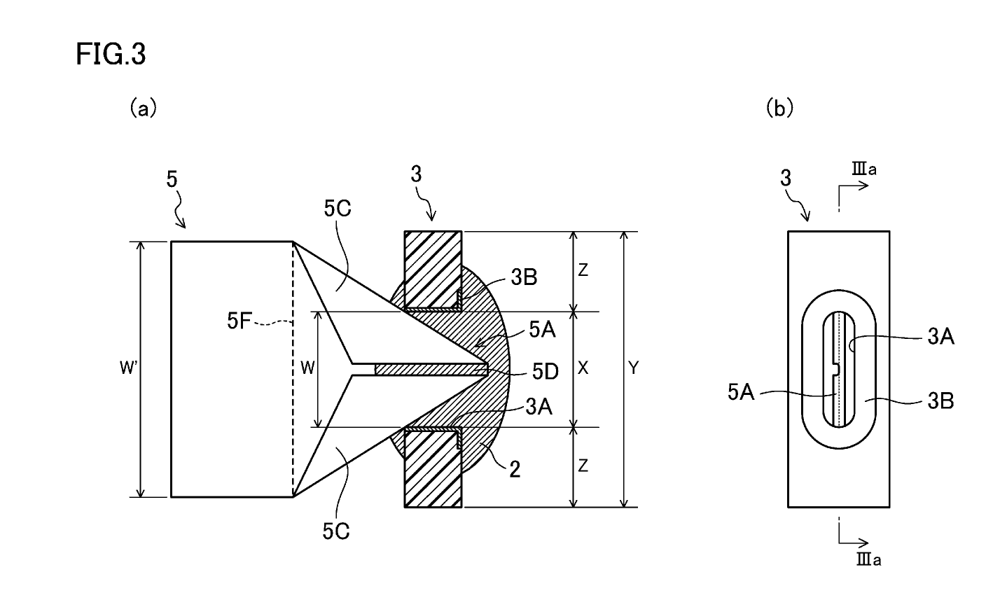

In this embodiment, the lead plate 5 includes the insertion part 5A that is folded, tapered and thicker than the other part of the lead plate 5. Here, the shape of the insertion part 5A of the lead plate 5 will be described with reference to FIGS. 2 and 3. FIG. 2(a) illustrates the shape of the unfolded insertion part of the lead plate in the battery pack of this embodiment. FIG. 2(b) illustrates the shape of the folded insertion part of the lead plate. FIGS. 3(a) and 3(b) illustrate that the insertion part of the lead plate in the battery pack of this embodiment is disposed in the insertion hole of the circuit board. FIG. 3(a) is a cross-sectional view taken along line IIIa-IIIa of FIG. 3(b). FIG. 3(b) is a plan view of the circuit board. Note that FIG. 3(b) omits solder 2 for simplicity.

FIG. 2(a) illustrates a metal plate cut into a pentagon shape. This pentagonal metal plate has vertexes, one of which is the tip end of the insertion part 5A of the lead plate 5. This tip end is disposed in the insertion hole 3A. Note that the lead plate 5 is made of a conductive material, particularly a metal plate. This metal plate includes e.g., iron, copper alloy, nickel, or aluminum as a base material. The surface of the metal plate is plated with e.g., nickel or tin alloy if necessary. The metal plate is about 0.1-0.3 mm in thickness. In this embodiment, the unfolded plate for the insertion part 5A is pentagonal as described above. Alternatively, as long as the insertion part 5A is folded and tapered, the shape of the unfolded plate may be polygonal. The shape may also be circular or elliptic.

FIGS. 2(a) and 2(b) illustrate that the insertion part 5A of the lead plate 5 includes corners disposed along the width direction thereof. Both of the corners are folded toward a central portion the lead plate 5. Note that the width direction of the lead plate 5 is the top-bottom direction in FIGS. 2(a) and 2(b). In other words, two vertex portions next to the vertex of the tip end of the insertion part 5A are folded along fold lines 5B toward the central portion. In this embodiment, both of the corners disposed along the width direction of the insertion part 5A are folded toward the central portion. Alternatively, both of the corners may be folded toward an inside, e.g., a position between the corner and the central portion. In addition, the insertion part 5A include two fold pieces 5C, which are the folded portions as described above. This folding makes the insertion part 5A tapered. The fold pieces 5C also make the insertion part 5A thicker, and improve its strength. Note that an excessively small radius of curvature of these folded portions might cause the lead plate 5 broken at the fold lines 5B. Thus, the radius of curvature needs to be adjusted to avoid such a break and also allow the insertion part 5A to be disposed in the insertion hole 3A of the circuit board 3.

FIGS. 3(a) and 3(b) illustrate that the insertion part 5A, which is folded, is disposed in the insertion hole 3A.

FIG. 3(a) illustrates that the lead plate 5 including the insertion part 5A, which is folded and tapered, has a break line 5F. A proper width W of a portion, of the insertion part 5A, disposed in the insertion hole 3A improves the strength of the insertion part 5A, and allows the insertion part 5A to be small.

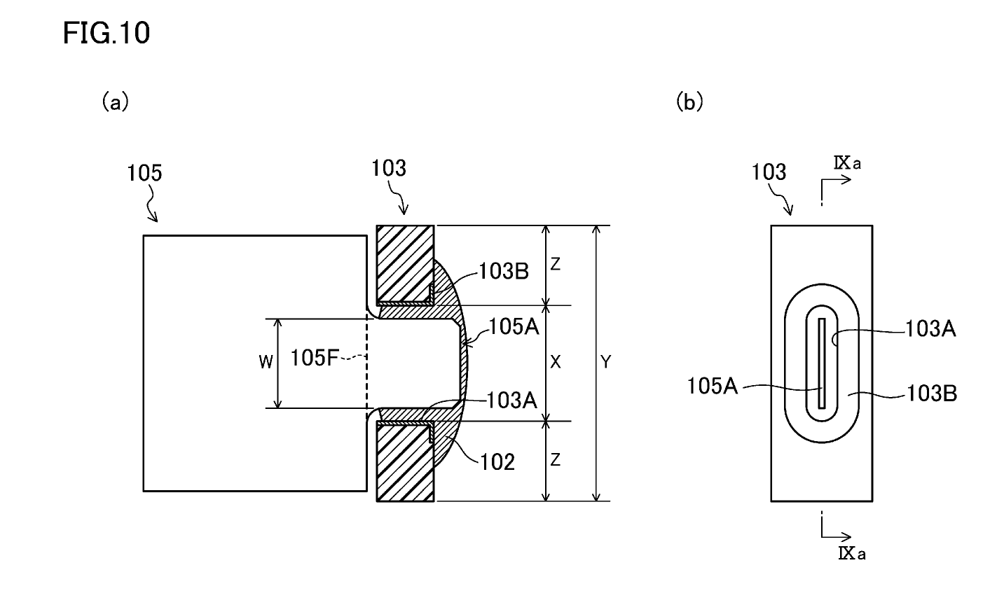

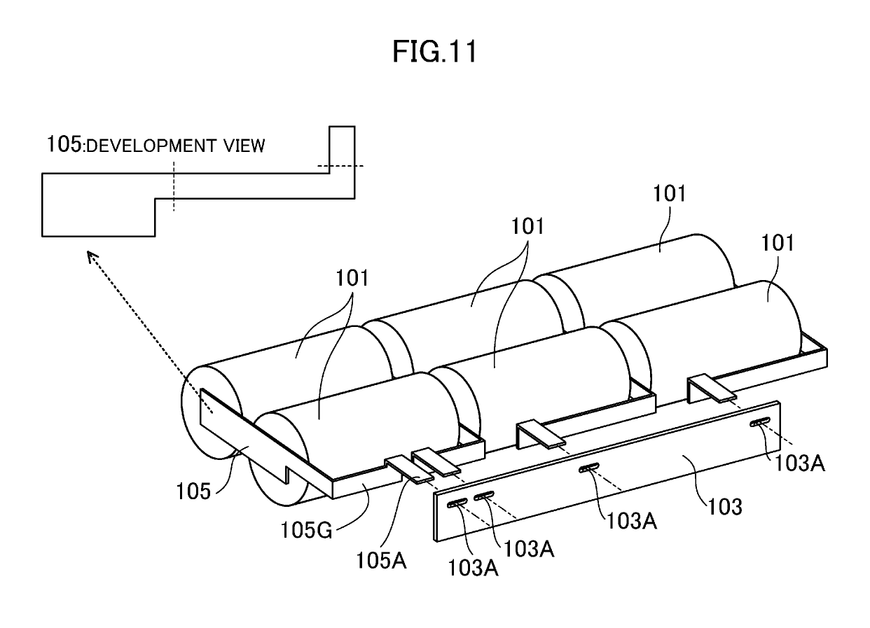

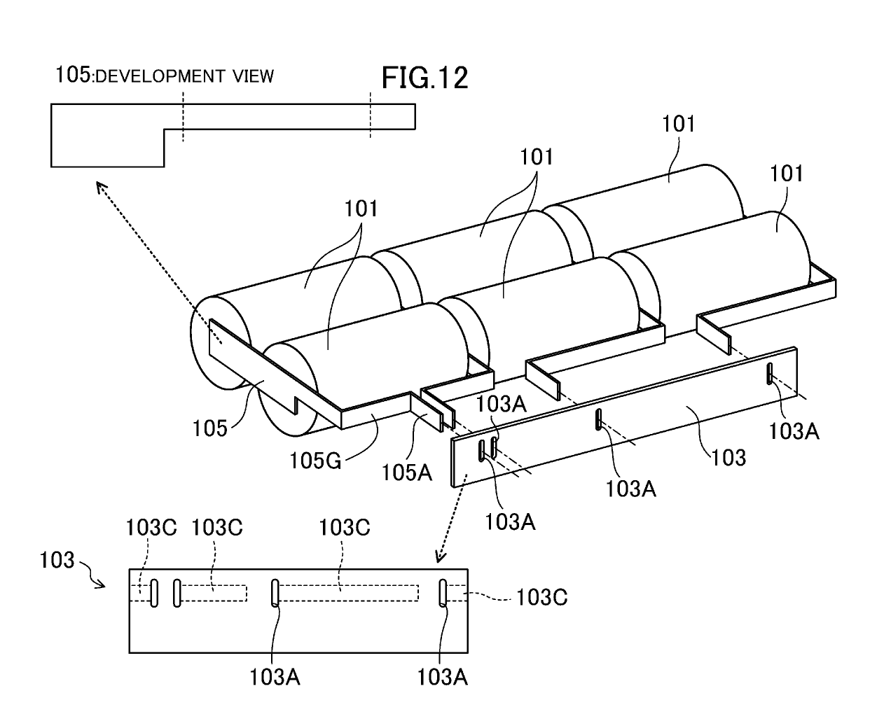

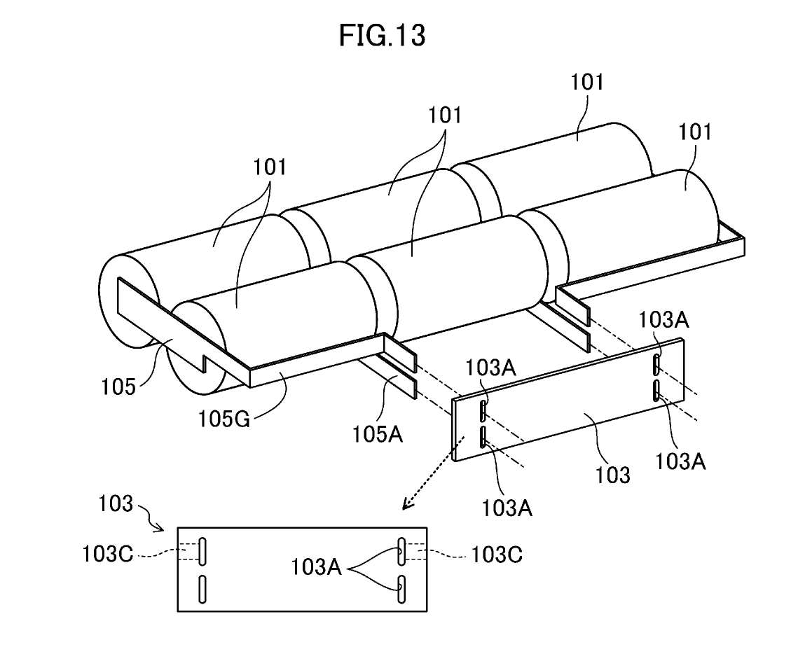

A dimension Y is along a vertical direction of the circuit board 3. A dimension X is along a vertical direction of the insertion hole 3A. A distance Z is from the insertion hole 3A to the end of the circuit board 3. The dimension Y is represented by Y=X+2Z. Note that the short side direction (the width direction) of the circuit board 3 is the vertical (top-bottom) direction. The long side direction (length direction) of the circuit board 3 is the lateral (right-left) direction. A conductive part 3B is provided on a wall surface and a periphery of the insertion hole 3A. The distance Z is a dimension depending on, e.g., the size of the conductive part 3B. The distance Z in FIG. 3 is the same setting value as that in FIG. 10, which illustrates a conventional battery pack. As described above, the configuration in this embodiment enables the insertion part 5A of the lead plate 5 to be small. Accordingly, the dimension X along the vertical direction of the insertion hole 3A can be small. The dimension Y along the vertical direction of the circuit board 3 can also be small. Consequently, the circuit board 3 can be small.

FIG. 3(b) illustrates the insertion hole 3A that is elliptic. Alternatively, the insertion hole 3A may be, e.g., circular. The insertion hole 3A that is circular can ease hole processing.

In addition, FIG. 3(a) illustrates that the insertion part 5A of the lead plate 5 is connected with the circuit board 3 through the solder 2. This insertion part 5A preferably includes a linear space 5D, which is a clearance between the two fold pieces 5C. This configuration can enable the solder 2 to be guided into the linear space 5D. This guided solder, which is filled into the clearance between the fold piece 5C and a surface overlapped by the fold piece 5C, is solidified. This solidified solder makes the insertion part 5A more solid. Note that the linear space 5D is preferably gradually tapered from the tip end to a base end of the insertion part 5A. This configuration promotes the capillary action of viscous fluid, and thus helps the liquid solder to be guided into the linear space 5D.

The battery pack of this embodiment includes the lead plate including the folded insertion part that is tapered. This configuration improves the strength of the insertion part of the lead plate. This configuration also enables the insertion part and the circuit board to be small. Consequently, the battery pack, which is small, has an improved impact resistance.

Second, a method for making the battery pack of this embodiment will be described.

First, the lead plate 5 is folded in advance as described above to form the insertion part 5A that is tapered and thicker than the other section in the lead plate 5. This lead plate 5 is connected with the batteries 1 by a welding method such as resistance welding. For example, two of these batteries are connected in parallel, and three in series. Next, the circuit board 3 is accommodated in the circuit board holder 7. Subsequently, the circuit board holder 7 is placed in the clearance space 6 between the batteries 1 welded as described above. Before this step, the insertion part 5A of the lead plate 5 is aligned with a position corresponding to the through hole 7A of the circuit board holder 7. In this manner, the insertion part 5A is inserted into the through hole 7A. Accordingly, the alignment rib 7B aligns the insertion hole 3A of the circuit board 3 with a position corresponding to through hole 7A. Thus, the insertion part 5A is guided and inserted into the insertion hole 3A of the circuit board 3. After the insertion of the insertion part 5A into the insertion hole 3A of the circuit board 3, this insertion portion is soldered to fix the circuit board 3 to the lead plate 5. Subsequently, this assembly is accommodated in a battery case (not shown), and the battery pack is completed.

As illustrated in FIG. 1(b), the size of the clearance space 6 depends on the outer diameter of the batteries 1 in use and a clearance P between the batteries 1. The clearance P is preferably about 1 mm in view of the miniaturization of the battery pack. In addition, for the clearance space 6 to accommodate the circuit board holder 7, the dimension Y along the width direction of the circuit board 3 needs to be less than or equal to 6 mm, and the width W of the portion, of the insertion part 5A, disposed in the insertion hole 3A needs to be less than or equal to 3 mm, in consideration of, e.g., the heights of the components mounted on the circuit board 3. The lead plate 5, of this embodiment, including the insertion part 5A being tapered and having the improved strength can be directly inserted into the circuit board 3 having a narrow width, and this insertion portion can be soldered.

The method for making the battery pack of this embodiment can improve the strength of the insertion part of the lead plate, and enables the insertion part and the circuit board to be small. Accordingly, the battery pack, which has the improved impact resistance, can be small. Moreover, in this method, the insertion part of the lead plate is directly inserted into the insertion hole of the circuit board having a narrow width, and this insertion portion is soldered. Thus, the workability of, e.g., soldering can be improved, and thus the battery pack including the clearance space used efficiently can be obtained.

In this embodiment, the circuit board holder 7 is provided to improve the assembly efficiency, and to insulate and separate the circuit board from the batteries. Alternatively, insulators such as insulating paper may be provided on side surfaces of the batteries in advance.

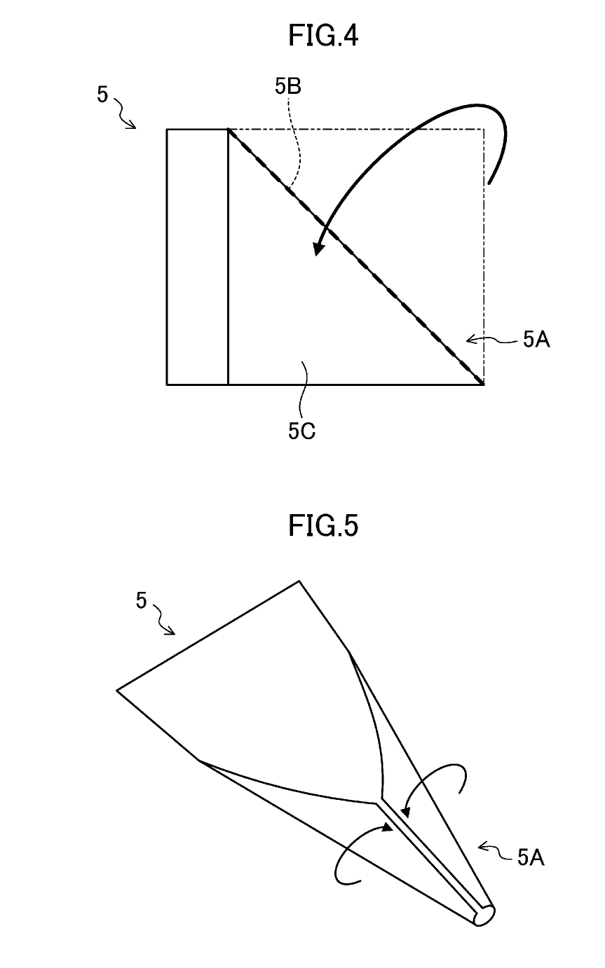

In this embodiment, as illustrated in FIGS. 2(a) and 2(b), the two fold lines 5B are provided for the insertion part 5A to include the two fold pieces 5C. First and second alternative examples of the insertion part 5A of this embodiment will be described with reference to FIGS. 4 and 5. FIG. 4 illustrates the first alternative example of the insertion part of the lead plate of the battery pack of this embodiment. FIG. 5 illustrates the second alternative example of the insertion part of the lead plate of the battery pack of this embodiment.

FIG. 4 illustrates the first alternative example of the first embodiment of the present invention. In this example, the insertion part 5A is formed by folding one corner of the insertion part 5A toward the other corner. These corners are disposed along the width direction of the insertion part 5A. Specifically, the insertion part 5A that is tapered is formed by forming one fold piece 5C. This fold piece 5C is along the fold line 5B extending from one of the two vertexes disposed on the tip end, of the insertion part 5A, inserted into the insertion hole 3A. The unfolded insertion part 5A is rectangular. This configuration reduces the number of folding.

FIG. 5 illustrates the second alternative example of the second embodiment of the present invention. In this example, the insertion part 5A of the lead plate 5 is not folded, but rolled along the width direction and generally conical in shape. In other words, the insertion part 5A of the lead plate 5 is rolled along the width direction and thus is tapered. This configuration reduces the break defects of the lead plate 5. This configuration also makes the insertion part 5A thick, and increase the strength.

### Second Embodiment

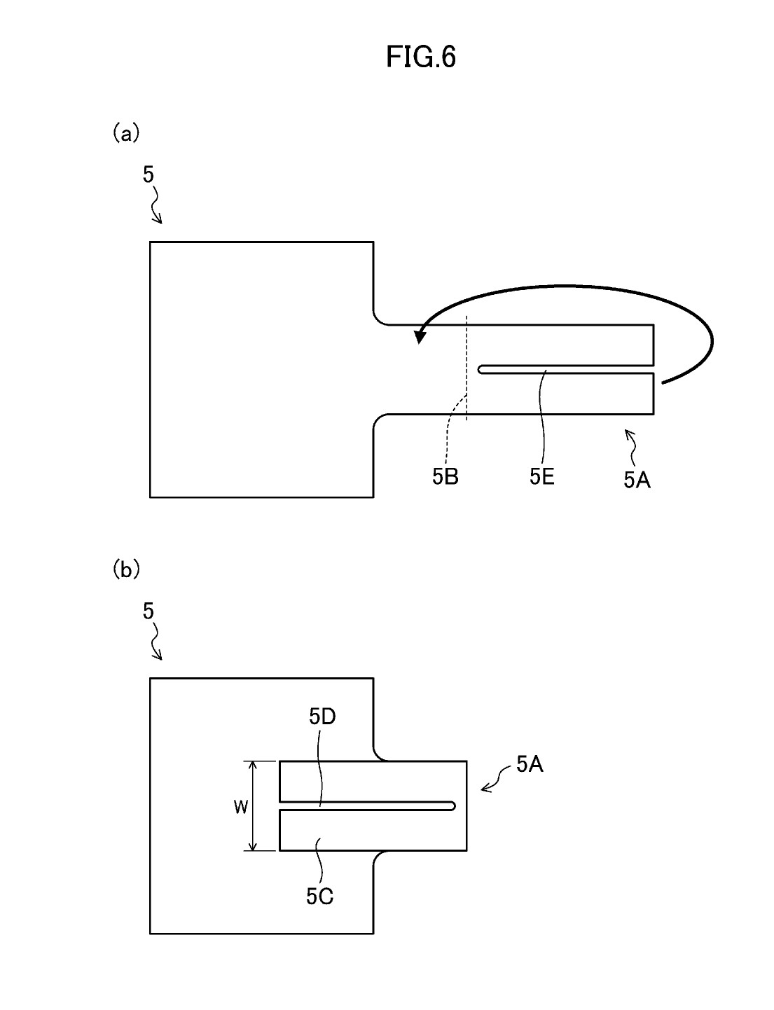

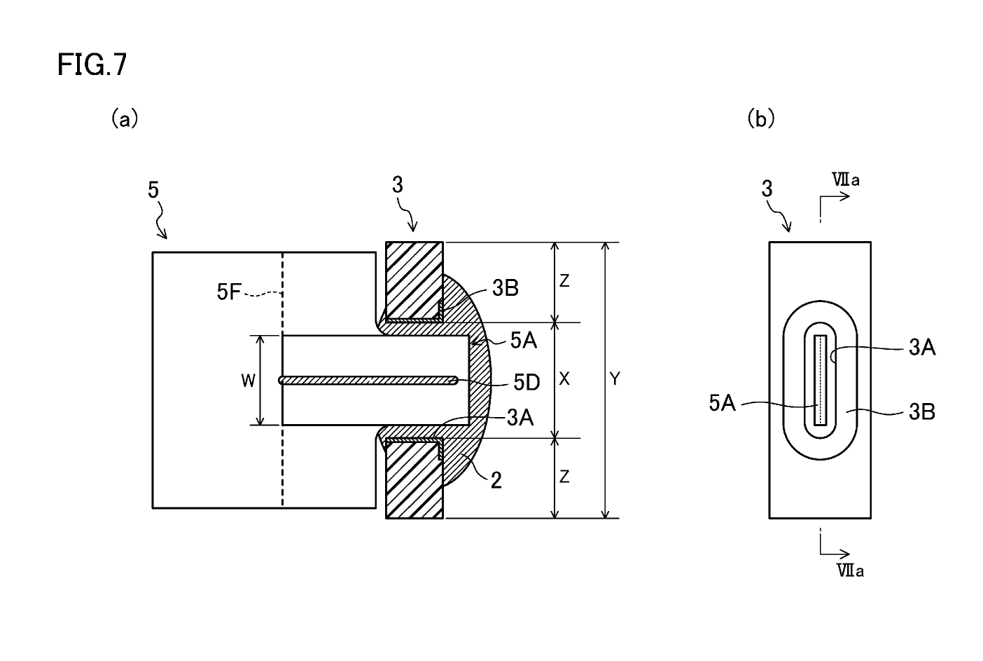

Next, a battery pack of a second embodiment of the present invention will be described with reference to FIGS. 6 and 7. FIG. 6(a) illustrates the shape of an insertion part of an unfolded lead plate of the battery pack of this embodiment. FIG. 6(b) illustrates the shape of the insertion part of a folded lead plate. FIGS. 7(a) and 7(b) illustrate that the insertion part of the lead plate of the battery pack of this embodiment is disposed in an insertion hole of a circuit board. FIG. 7(a) is a cross-sectional view taken along line VIIa-VIIa of FIG. 7(b). FIG. 7(b) is a plan view of the circuit board. Note that FIG. 7(b) omits solder 2 for simplicity. Only the shape of the lead plate 5 of this embodiment is different from that of the first embodiment. Thus, only this difference will be described. The descriptions of the same elements will be omitted.

FIG. 6(a) illustrates the unfolded insertion part 5A of this embodiment. The unfolded insertion part 5A is rectangular. A tip end, of this unfolded insertion part 5A, disposed in an insertion hole 3A, is narrower in width than a base end of the unfolded insertion part 5A. The insertion part 5A is folded from the tip end to the base end along a fold line 5B extending along the width direction. Accordingly, as illustrated in FIG. 6(b), a fold piece 5C and the insertion part 5A that is thicker than the other part of the lead plate 5 are formed.

FIGS. 7(a) and 7 (b) illustrate that the folded insertion part 5A is disposed in the insertion hole 3A.

Note that, as illustrated in FIG. 6(a), the insertion part 5A preferably includes a slit 5E along the length direction. FIG. 6(b) illustrates that the slit 5E of the folded insertion part 5A serves as a linear space 5D. FIG. 7(a) illustrates that the solder 2 is guided to the linear space 5D. This solder 2, which is filled into a clearance sandwiched by the lead plate 5, is solidified. This solidified solder makes the insertion part 5A solid.

The insertion part 5A that is folded as described above has an increased strength. Thus, a break line 5F of the lead plate 5 is positioned as illustrated in FIG. 7(a). A dimension V depends on a geometric relation between the outer shape of the unfolded insertion part and the fold line 5B. The dimension V that is long increases the strength of the insertion part 5A, ands make the insertion part 5A small. Thus, the length of the fold piece 5C is preferably larger than at least the thickness of the circuit board 3.

The battery pack of this embodiment includes the lead plate including the insertion part with the improved strength. The battery pack of this embodiment includes the small insertion part. The battery pack of this embodiment includes the small circuit board. Accordingly, the battery pack, which is small, has the improved impact resistance.

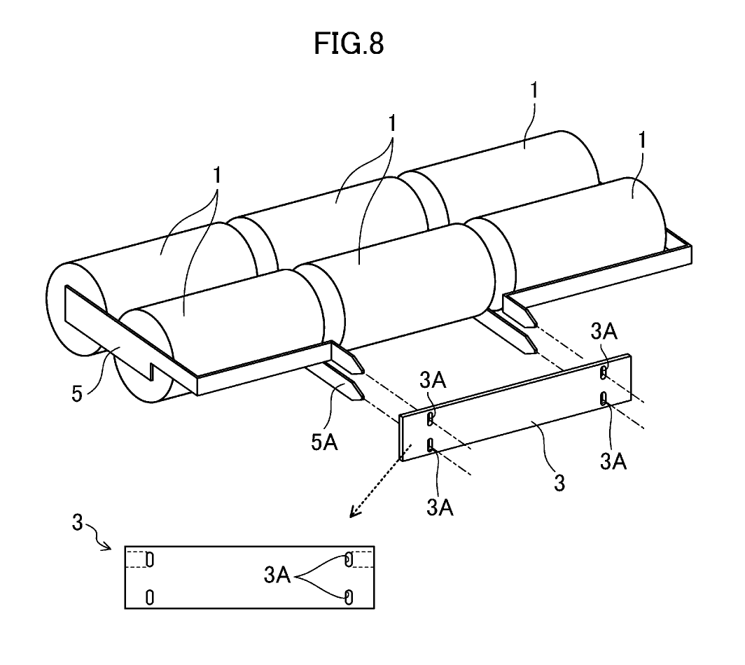

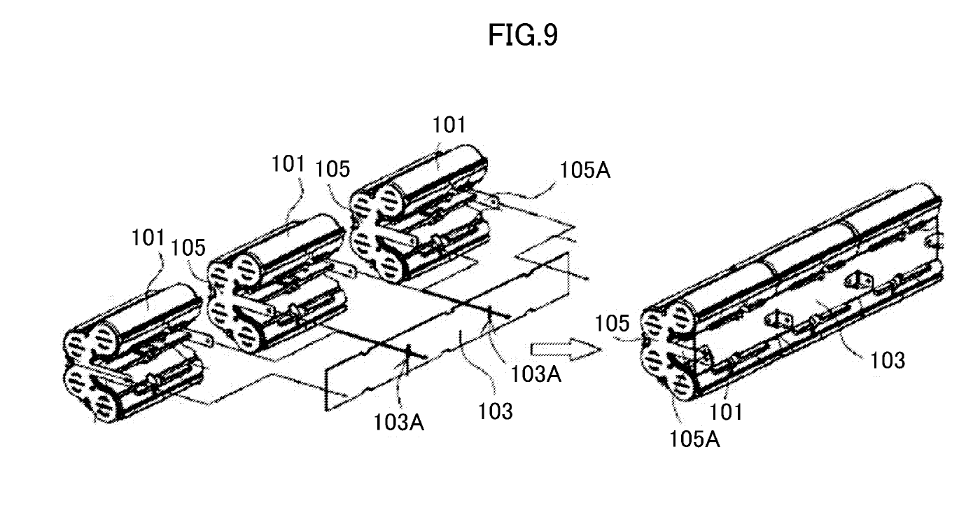

FIG. 8 illustrates an embodiment where a circuit board 3 is disposed on side surfaces of batteries 1. The lead plate 5, of the above-described embodiment, including the insertion part 5A having the tapered tip end makes an insertion hole 3A of the circuit board 3 of this embodiment small, and makes the width of the circuit board 3 narrow.

### INDUSTRIAL APPLICABILITY

The battery pack of the present invention has an excellent impact resistance. The battery pack of the present invention is also small and economical. The battery pack of the present invention serves as a power supply including a plurality of batteries connected in parallel or series for electrical machinery such as laptop computers, video cameras, etc.; electric tools; or electric bicycles.

### DESCRIPTION OF REFERENCE CHARACTERS

1 Battery
2 Solder
3 Circuit Board
3A Insertion Hole
3B Conductive Part
5 Lead Plate
5A Insertion Part
5B Fold Line
5C Fold Piece
5D Linear Space
5E Slit
5F Break Line
6 Clearance Space
7 Circuit Board Holder
7A Through Hole
7B Alignment Rib

1. A battery pack, comprising:
a plurality of batteries connected with one another;
a lead plate connected with the plurality of batteries, and made of a conductive material; and
a circuit board connected with the plurality of batteries through the lead plate, wherein
the circuit board includes insertion holes passing through the circuit board along a thickness thereof,
the lead plate includes an insertion part disposed in the insertion hole,
the insertion part is folded, and
a portion from a tip end of the insertion part to a wider portion of the insertion part than the insertion hole is thicker than the other part of the lead plate.

2. The battery pack of claim 1, wherein
the insertion part is tapered, and includes two fold pieces formed by folding both corners, of the insertion part, disposed along a width direction thereof toward an inside of the lead plate.

3. The battery pack of claim 2, wherein
a clearance resides between the two fold pieces.

4. The battery pack of claim 3, wherein
the clearance is gradually tapered from a tip end to a base end of the insertion part.

5. The battery pack of claim 1, wherein
the insertion part is tapered, and includes one fold piece formed by folding one corner, of the insertion part, disposed along a width direction thereof toward another corner.

6. The battery pack of claim 1, wherein
the insertion part includes one fold piece formed by folding a tip end of the insertion part toward a base end thereof.

7. The battery pack of claim 6, wherein
the insertion part includes a slit along a length direction of the insertion part.

8. The battery pack of claim 6, wherein
a length of the fold piece is larger than a thickness of the circuit board.

9. The battery pack of claim 1, wherein
the insertion part is not folded but rolled along a width direction thereof and generally conical in shape.
